(19) United States
(12) Patent Application Publication
(10) Pub. No.: US 2016/0087268 A1
(43) Pub. Date: Mar. 24, 2016

(54) NEGATIVE ELECTRODE MATERIAL FOR NONAQUEOUS ELECTROLYTE SECONDARY BATTERY, NEGATIVE ELECTRODE FOR NONAQUEOUS ELECTROLYTE SECONDARY BATTERY, NONAQUEOUS ELECTROLYTE SECONDARY BATTERY AND BATTERY PACK

(71) Applicant: Kabushiki Kaisha Toshiba, Minato-ku (JP)

(72) Inventors: Yasuyuki HOTTA, Ota (JP); Takashi KUBOKl, Ota (JP); Tomokazu MORITA, Funabashi (JP)

(73) Assignee: Kabushiki Kaisha Toshiba, Minato-ku (JP)

(21) Appl. No.: 14/854,231

(22) Filed: Sep. 15, 2015

(30) Foreign Application Priority Data
Sep. 19, 2014 (JP) 2014-191450

(51) Int. Cl. H01M 4/36; H01M 10/0525; H01M 4/38

(52) U.S. Cl. CPC H01M 4/366; H01M 4/386; H01M 4/382; H01M 10/0525; H01M 2220/20; H01M 2220/30

(57) ABSTRACT

A negative electrode material for a nonaqueous electrolyte secondary battery of the embodiment include: at least one selected from a silicon oxide composite particle and a lithium-containing silicon oxide composite particle which is the silicon oxide composite particle containing lithium; and an organic molecule R, wherein the silicon oxide composite particle contains a silicon particle, a silicon oxide phase formed of SiOₓ (1≦x≦2) and a silicon phase formed of Si which is contained or held in the silicon oxide phase, and the organic molecule R is bonded through a urethane bond to at least one of a surface layer part of the silicon particle and a surface layer part of the silicon oxide phase.

### CROSS-REFERENCE TO RELATED APPLICATION

This application is based upon and claims the benefit of priority from Japanese Patent Application No. 2014-191450, filed Sep. 19, 2014, the entire contents of which are incorporated herein by reference.

### FIELD

Embodiments described herein relate generally to a negative electrode material for a nonaqueous electrolyte secondary battery, a negative electrode material for a nonaqueous electrolyte secondary battery, a nonaqueous electrolyte secondary battery and a battery pack.

### BACKGROUND

In recent years, the miniaturization technology for electronic devices has been rapidly developed, and various kinds of portable electronic devices are becoming popular. Also, a battery, which is a power supply for these portable electronic devices, has been required to be miniaturized, and a nonaqueous electrolyte secondary battery having high energy density is attracting attention.

The nonaqueous electrolyte secondary battery obtained by using metallic lithium as a negative electrode active material is characterized in that the battery life is short because a dendritic crystal called dendrite precipitates on a negative electrode during charge although energy density is very high. Also, in this nonaqueous electrolyte secondary battery, dendrite can be grown so as to reach a positive electrode, thereby causing an internal short circuit, and there are problems in safety. Therefore, a carbon material capable of absorbing and desorbing lithium, specifically graphitic carbon, has been used as a negative electrode active material substituted for metallic lithium.

In order to increase the energy density of a nonaqueous electrolyte secondary battery, it has been attempted to use materials having large lithium storage capacity and high density for a negative electrode active material. Examples of such materials include an amorphous chalcogen compound and elements such as silicon and tin which form an alloy with lithium. Among these materials, silicon can absorb lithium until the atomic ratio Li/Si of lithium atoms to silicon atoms reaches 4.4. Thus, the negative electrode capacity per mass of the negative electrode active material is about 10 times as large as that of graphitic carbon.

However, silicon oxides produced when handling silicon undergo the insertion of lithium to thereby form stable lithium silicates. These lithium silicates cause the irreversible capacity, and there is the problem of the reduction in the charge and discharge efficiency.

### BRIEF DESCRIPTION OF DRAWINGS

FIG. 1 is a schematic view illustrating the electrode according to the second embodiment.

FIG. 2 is a schematic view illustrating the nonaqueous electrolyte secondary battery according to the third embodiment.

FIG. 3 is a schematic view illustrating the nonaqueous electrolyte secondary battery according to the third embodiment.

FIG. 4 is a schematic view illustrating the nonaqueous electrolyte secondary battery according to the third embodiment.

FIG. 5 is a schematic view illustrating the nonaqueous electrolyte secondary battery according to the third embodiment.

FIG. 6 is a schematic perspective view illustrating the battery pack according to the fourth embodiment.

FIG. 7 is a schematic view illustrating the battery pack according to the fourth embodiment.

### DETAILED DESCRIPTION

Hereinafter, the embodiments of a negative electrode material for a nonaqueous electrolyte secondary battery, a negative electrode material for a nonaqueous electrolyte secondary battery, a nonaqueous electrolyte secondary battery and a battery pack are described with reference to the drawings.

### First Embodiment

The first embodiment provides the negative electrode material for a nonaqueous electrolyte secondary battery including: at least one selected from a silicon particle, a silicon oxide composite particle and a lithium-containing silicon oxide composite particle; and an organic molecule R.

The silicon oxide composite particle contains a silicon oxide phase formed of SiOₓ (1≦x≦2) and a silicon phase formed of Si which is contained or held in the silicon oxide phase.

The lithium-containing silicon oxide composite particle is the silicon oxide composite particle containing lithium.

The organic molecule R is bonded through a urethane bond to at least one of a surface layer part of the silicon particle and a surface layer part of the silicon oxide phase.

The organic molecule R represents a chain hydrocarbon group having 1 to 20 carbon atoms, cyclic hydrocarbon group having 1 to 20 carbon atoms or an aromatic hydrocarbon group having 1 to 20 carbon atoms; or a chain hydrocarbon group having 1 to 20 carbon atoms, cyclic hydrocarbon group having 1 to 20 carbon atoms or an aromatic hydrocarbon group having 1 to 20 carbon atoms in which at least one of carbon and hydrogen atoms are substituted by at least one selected from the group consisting of a halogen atom, an oxygen atom, a sulfur atom, a nitrogen atom and a silicon atom. The negative electrode material for a nonaqueous electrolyte secondary battery according to the present embodiment is used as the material for forming a negative electrode for a nonaqueous electrolyte secondary battery.

As the negative electrode material for a nonaqueous electrolyte secondary battery according to the present embodiment (hereinafter abbreviated as “negative electrode material”), metal lithium or a lithium alloy; a carbonaceous material capable of absorbing and releasing lithium [cokes, graphitcs (such as natural graphite or artificial graphite), pyrolytic carbons, sintered bodies of organic polymer compounds, carbon fibers and activated carbon]; or an element selected from the group consisting of Si, Sn, Al, In, Ga, Pb, Ti, Ni, Mg, W, Mo and Fe, and the alloys and the oxides thereof is used alone or in combination of two or more.

Of these negative electrode materials, the preferable one is the particle made of the composite having fine silicon monoxide as a main component, in which fine crystal Si is contained or held in the silicon oxide phase containing SiO₂ that is strongly bonded to Si, and these are finely complexed.

In this kind of particle, it is preferable that the average size of the silicon oxide phase containing and holding Si be 50 nm or more and 10 μm or less. Also, regarding the size distribution of the particle, the value of (standard deviation/average size) is preferably 1.0 or less when 16% cumulative diameter in volume fraction is represented by d16%, 84% cumulative diameter is represented by d84%, and the value represented by (d84%−d16%)/2 is defined as the standard deviation. When the size distribution of the particle is within the aforementioned range, there are the particles having a uniform size.

A large amount of lithium is inserted in or eliminated from the silicon phase of the negative electrode material, and the capacity of the negative electrode is much increased by the silicon phase. In the present embodiment, the silicon phase is dispersed in the silicon oxide phase, and therefore, it is reduced that the negative electrode material is expanded or contracted by the insertion and elimination of a large amount of lithium at the silicone phase. As a result, the negative electrode material particle is prevented from being pulverized. Also, the carbonaceous material is mixed in metal lithium or a lithium alloy, and therefore, the electroconductivity that is important for the negative electrode material is ensured. In addition, the silicon oxide phase of the negative electrode material is tightly bonded to silicon, which exerts the large effect to keep the particle structure as the buffer for holding the miniaturized silicon.

In the silicon phase of the negative electrode material, the expansion and contraction are large during the absorption and release of lithium. In order to reduce the stress caused by the expansion and contraction, it is preferable that the Si phase be preferably miniaturized as much as possible and be dispersed. Specifically, it is preferable that the silicon phase be a cluster having a size of several nanometers or more and 100 nm or less and be dispersed in the silicon oxide phase.

Although the silicon oxide phase of the negative electrode material can form a structure such as amorphia or crystal, it is preferable that the silicon oxide phase be bonded to the silicon phase and be uniformly dispersed in the negative electrode material particle in the state of including or holding the silicon phase. However, when repeating the volume change by absorbing and releasing lithium during charge and discharge, the microcrystals Si held in the silicon oxide phase are bonded to each other, and the crystallite size is grown, which causes the reduction in the charge and discharge capacity and initial charge and discharge efficiency of the nonaqueous electrolyte secondary battery produced by using the negative electrode material according to the present embodiment.

Therefore, in the present embodiment, the size of the silicon oxide phase is adjusted to be small and uniform, to thereby inhibit the growth of the crystallite size of the microcrystalline Si, suppress the capacity deterioration due to charge and discharge cycles, and improve the service life of the nonaqueous electrolyte secondary battery produced by using the negative electrode material according to the present embodiment.

The average size of the silicon oxide phase is preferably within a range of 50 nm or more and 10 μm or less, and more preferably within a range of 100 nm or more and less than 1000 nm. Herein, the size of the silicon oxide phase indicates the value of the diameter when the cross-sectional shape of the silicon oxide phase is converted into the circle having the same area as the cross-sectional shape.

When the average size of the silicon oxide phase is less than 50 nm, it becomes difficult to disperse the silicon oxide phase during the production of the negative electrode material, and the electroconductivity of the negative electrode material is reduced, and eventually, the problems such as the reduction in the rate characteristics and the initial charge and discharge efficiency occur. Meanwhile, when the average size of the silicon oxide phase is more than 10 μm, it is not possible to obtain the effect of suppressing the growth of the crystallite size of the microcrystalline Si. Also, when the average size of the silicon oxide phase is within the range of 100 nm or more and 1000 nm or less, it is possible to improve the service life of the nonaqueous electrolyte secondary battery produced by using the negative electrode material according to the present embodiment.

Also, in order to obtain the good properties as the whole negative electrode material, the size of the silicon oxide phase is preferably uniform. Also, regarding the size distribution of the silicon oxide phase, the value of (standard deviation/average size) is preferably 1.0 or less and more preferably 0.5 or less when 16% cumulative diameter in volume fraction is represented by d16%, 84% cumulative diameter is represented by d84%, and the value represented by (d84%−d16%)/2 is defined as the standard deviation. When the size distribution of the silicon oxide phase is within the aforementioned range, it is possible to improve the service life of the nonaqueous electrolyte secondary battery produced by using the negative electrode material according to the present embodiment.

The oxidized layer, i.e. the silicon oxide phase, exists partially on the surface of the silicon-based particle which functions as the negative electrode material. When the surface of the silicon oxide phase existing on the surface of the silicon-based particle is coated with the organic molecule R, it is possible to improve the initial charge and discharge efficiency. When the surface of the silicon oxide phase is coated with the organic molecule R, the lithium silicate such as Li₄SiO₄ is formed on the silicon oxide phase by the insertion of Li as a stable phase, which reduces the initial charge and discharge efficiency as irreversible capacity.

By coating the surface of the silicon oxide phase with the organic molecule R, it is possible to prevent the insertion of Li into the silicon oxide phase and to suppress the formation of the lithium silicate. Examples of the method of coating the surface of the silicon oxide phase with the organic molecule R include the method of coupling the hydroxyl group existing on the surface of the silicon oxide phase with the organic molecule R-containing isocyanate compound through the coupling reaction. The coupling reaction proceeds easily.

The coupling reaction of the hydroxyl group (—OH) existing on the surface of the silicon oxide phase and the organic molecule R-containing isocyanate compound (O═C═N—R) is represented by the following reaction formula (1). In this coupling reaction, the silicon oxide phase and the organic molecule R of the isocyanate compound are coupled through the urethane bond (—OCONH—).

—Si—OH+O═C═N—R→Si—OCONH—R (1)

The organic molecule R represents a chain hydrocarbon group having 1 to 20 carbon atoms, cyclic hydrocarbon group having 1 to 20 carbon atoms or an aromatic hydrocarbon group having 1 to 20 carbon atoms; or a chain hydrocarbon group having 1 to 20 carbon atoms, cyclic hydrocarbon group having 1 to 20 carbon atoms or an aromatic hydrocarbon group having 1 to 20 carbon atoms in which at least one of carbon and hydrogen atoms are substituted by at least one selected from the group consisting of a halogen atom, an oxygen atom, a sulfur atom, a nitrogen atom and a silicon atom.

Examples of the chain hydrocarbon group having 1 to 20 carbon atoms include simple alkyl groups such as a methyl group, an ethyl group, an n-propyl group, an iso-propyl group, an n-butyl group, an iso-butyl group, a sec-butyl group, a tert-butyl group, a pentyl group, an iso-pentyl group, a sec-pentyl group, a hexyl group, a heptyl group, an octyl group, a 2-ethylhexyl group, a nonyl group, a decyl group and a dodecyl group.

Examples of the cyclic hydrocarbon group having 1 to 20 carbon atoms include a cyclohexyl group, an isophorone group and a dicyclohexylmethane group.

Examples of the aromatic hydrocarbon group having 1 to 20 carbon atoms include a phenyl group, a tolyl group, a xylyl group, a naphthyl group and a biphenyl group.

In the present embodiment, usable examples of the isocyanate compound include the isocyanatc compound obtained by bonding one isocyanatc group to the organic molecule R and the diisocyanate compound obtained by bonding two isocyanate groups to the organic molecule R. Of these, the diisocyanate compound is preferable because it intensely reacts with the hydroxy group existing on the surface of the silicon oxide phase.

Examples of the diisocyanate compound include diethylene diisocyanate, tetramethylene diisocyanate, pentamethylene diisocyanate, hexamethylene diisocyanate, 1,3-bis(isocyanatomethyl)benzene, 1,4-bis(diisocyanate methyl)benzene, 2,4-tolylene diisocyanate, 2,6-diisocyanate, diphenylmethane diisocyanate, naphthalene diisocyanate, and alicyclic compounds produced by hydrogenating these diisocyanate compounds, and isophorone diisocyanate.

The SiO₂ precursor and the Li compound can be added in the organic molecule R-containing isocyanate compound which coats at least a part of the silicon oxide phase exposed on the surfaces of the silicon phase and the silicon oxide phase. By adding these materials in the aforementioned isocyanate compound, the bond between the SiO₂ contained in the isocyanate compound and the organic molecule R of the isocyanate compound becomes strong, and Li₄SiO₄ having the excellent Li ion conductivity is produced in the silicon oxide phase.

Examples of the SiO₂ precursor include alkoxides such as silicon ethoxide.

Examples of the Li compound include lithium carbonate, lithium oxide, lithium hydroxide, lithium oxalate, and lithium chloride.

The particle size of the particle of the negative electrode material according to the present embodiment is preferably 5 μm or more and 100 μm or less. The specific surface area of the particle of the negative electrode material is preferably 0.5 m²/g or more and 10 m²/g or less. The particle size and the specific surface area of the particle of the negative electrode material have an effect on the rate of the insertion and elimination reactions of lithium, and largely affect the negative electrode characteristics. However, when the particle size and the specific surface area are within the aforementioned ranges, it is possible to stably exert the negative electrode characteristics.

Also, the half-value width of the diffraction peak of the Si (220) plane in the powder X-ray diffraction measurement of the negative electrode material is preferably 1.5° or more and 8.0° or less.

The half-width of the diffraction peak of Si (220) plane decreases as the crystal grain of the silicon phase grows. When the crystal grain of the silicon phase grows largely, the problem such as crack is likely to occur in the negative electrode material particle by the expansion and contraction accompanied with the insertion and elimination of lithium. Therefore, when the half-width of the diffraction peak of Si (220) plane is within the range of 1.5° or more and 8.0° or less, it is possible to prevent the aforementioned problem from occurring.

Herein, it is preferable that the carbonaceous material be complexed with the composite obtained by containing or holding the fine crystal Si in the silicon oxide phase containing SiO₂ that is strongly bonded to Si before the aforementioned coupling reaction.

The carbonaceous material, which is complexed with the silicon phase and the silicon oxide phase in the negative electrode material particle, is preferably at least one selected from the group consisting of graphite, hard carbon, soft carbon, amorphous carbon and acetylene black, and more preferably only graphite or the mixture of graphite and hard carbon. Graphite is preferable in terms of the enhancement in the electroconductivity of the negative electrode material. Hard carbon is preferable in that the effect of reducing the expansion and contraction of the negative electrode material particle is significantly exerted by coating the entire negative electrode material particle. It is preferable that the carbonaceous material have a shape that encloses the silicon phase and the silicon oxide phase.

Also, it is preferable that the composite contain a carbon fiber in order to keep the structure of the fine particle, to prevent the aggregation of the silicon oxide phase and to ensure the electroconductivity in the composite in which the particle-shaped silicon oxide phase is dispersed.

Therefore, it is effective that the diameter of the carbon fibers to be added be the almost same as the size of the silicon oxide phase. The average size (average diameter) of the carbon fibers is preferably 50 nm or more and 10 μm or less, and more preferably 100 nm or more and 1,000 nm or less.

The content of the carbon fibers in the composite, in which the particle-shaped silicon oxide phase is dispersed, is preferably 0.1 mass % or more and 10 mass % or less and more preferably 0.5 mass % or more and 5 mass % or less.

In the negative electrode material of the present embodiment, the quantitative relationship between the silicon phase and the silicon oxide phase is preferably adjusted such that the molar ratio of Si and SiO₂ falls within a range of 0.6≦Si/SiO₂≦1.5. When this quantitative relationship is satisfied, the negative electrode material can obtain a large charge and discharge capacity and good cycle characteristics. Also, when using the negative electrode material in which the silicon phase, the silicon oxide phase and the carbonaceous material phase are complexed, the ratio thereof is preferably adjusted such that the molar ratio of Si and carbon (C) falls within a range of range of 0.2≦Si/C≦2.

Next, the production method of the negative electrode material for a nonaqueous electrolyte secondary battery according to the present embodiment is described.

Examples of the method of coupling the hydroxyl group existing on the surface of the silicon oxide phase with the organic molecule R-containing isocyanate compound by the coupling reaction such that a part or the whole of the surface of the silicon oxide phase is coated with the organic molecule R, include the method of dissolving the organic molecule R-containing isocyanate compound is dissolved in a solvent so as to prepare the isocyanate compound solution and bringing the isocyanate compound solution into contact with the silicon-based particle. Through this method, the coupling reaction of the hydroxyl group existing on the surface of the silicon oxide phase and the isocyanate compound readily proceeds, and it is possible to coat a part or the whole of the surface of the silicon oxide phase with the organic molecule R.

There is no particular limitation to the method of bringing the silicon oxide phase of the silicon particle, the silicon oxide composite particle and the lithium-containing silicon oxide composite particle (hereinafter generically referred to as the “silicon-based particle”) into contact with the organic molecule R-containing isocyanate compound. However, it is preferable to uniformly bring the silicon oxide phase of the silicon-based particle into contact with the organic molecule R-containing isocyanate compound. Examples of the method of bringing the silicon oxide phase of the silicon-based particle into contact with the organic molecule R-containing isocyanate compound include the method of immersing the silicon-based particle in the isocyanate compound solution and the method of spraying the isocyanate compound solution to the silicon-based particle by using a spray, etc.

Also, the temperature when bringing the silicon oxide phase of the silicon-based particle into contact with the organic molecule R-containing isocyanate compound is preferably within a range of 25° C. to 100° C. and more preferably within a range of 30° C. to 80° C. The temperature of the isocyanate compound solution is appropriately adjusted in consideration of the boiling point of the solvent and the vapor pressure, etc.

Because the isocyanate group of the organic molecule R-containing isocyanate compound reacts with only the silanol group (Si—OH) by the aforementioned treatment, it is possible to coat only the surface of the silicon oxide phase of the silicon-based particle with the organic molecule R.

Examples of the solvent for dissolving the organic molecule R-containing isocyanate compound include hydrocarbon-based alcohols such as methanol, ethanol, propanol, isopropanol, butanol, tert-butanol, pentanol, hexanol, heptanol and octanol; hydrocarbon-based ketones such as acetone, propanone, methyl ethyl ketone, methyl isobutyl ketone and cyclohexanone; hydrocarbon ethers such as diethyl ether, ethylene glycol dimethyl ether, diethylene glycol dimethyl ether and tetrahydrofuran; hydrocarbon-based esters such as methyl acetate, ethyl acetate, butyl acetate and γ-butyrolactone; and other organic solvents such as toluene, xylene, dimethylformamide, dimethylacetamide, dimethyl sulfoxide, dichloromethane, chloroform, carbon tetrachloride and dichloroethane.

The concentration of the organic molecule R-containing isocyanate compound in the isocyanate compound solution is preferably within a range of 0.001 mol/l to 1 mol/l and more preferably within the range of 0.01 mol/l to 0.5 mol/l.

In order to reduce the adhesion of the excess isocyanate compound, it is preferable to lower the concentration of the isocyanate compound in the isocyanate compound solution. However, when the concentration is too low, the coupling reaction of the hydroxyl group existing on the surface of the silicon oxide phase and the isocyanate compound does not proceed sufficiently. Therefore, the concentration of the isocyanate compound in the isocyanate compound solution is preferably within the aforementioned range.

After bringing the silicon oxide phase of the silicon-based particle into contact with the organic molecule R-containing isocyanate compound, it is effective to carry out the washing step of dissolving and removing the excess isocyanate compound adhering to the surface of the silicon-based particle in a solvent.

Examples of the solvent used in the washing step include the solvents capable of dissolving the organic molecule R-containing isocyanate compound such as the aforementioned solvents.

In this washing step, there is no particular limitation to the method of dissolving and removing the excess isocyanate compound adhering to the surface of the silicon-based particle in the solvent. Examples of the method of dissolving and removing the excess isocyanate compound adhering to the surface of the silicon-based particle in the solvent, include the method of immersing the silicon-based particle in the solvent so as to dissolve the excess isocyanate compound in the solvent, and the method of spraying the solvent to the silicon-based particle by using a spray, etc. so as to wash the excess isocyanate compound with the solvent.

Also, after the end of the washing step, in order to remove the solvent, it is possible to carry out the drying step in which the silicon-based particle is dried by heating up to about 100° C. In the drying step, it is possible to use the method of drying the silicon-based particle with hot air and the method of introducing the silicon-based particle into an oven and drying the silicon-based particle.

In the complexing treatment of the carbonaceous material and the composite obtained by containing or holding the fine crystal Si in the silicon oxide phase containing SiO₂ that is strongly bonded to Si, SiOₓ produces a silicon crystal through the disproportionation reaction, which forms the silicon-based particle that are separated into two phases of the silicon phase and the silicon oxide phase. Then, this silicon-based particle is mixed with the organic material and the particle in which the surface of the silicon oxide is selectively coupled (bonded) with the organic molecule R-containing isocyanate compound, to thereby form the composite.

Usable examples of the organic material include at least one selected from the group consisting of carbon materials such as graphite, coke, low-temperature burned carbon and pitch and carbon material precursors thereof. In particular, the organic material, which is melted by heating, such as pitch is melted during the mechanical milling treatment (complexing treatment), and the complexing does not proceed well. Therefore, the organic material, which is melted by heating, is mixed preferably with the organic material, which is not melted during the mechanical milling treatment, such as graphite or coke.

Examples of the mechanical complexing treatment include the method using a device such as a turbo mill, a ball mill, a mechano-fusion or a disk mill.

The conditions for the mechanical complexing treatment vary according to the respective devices to be used, and it is preferable to carry out the mechanical complexing treatment until the material is sufficiently pulverized and the complexing proceeds sufficiently. However, when increasing the power too much and spending the time too much during the complexing, the silicon and the carbon are reacted to thereby produce the silicon carbide that is unreactive for the insertion reaction of lithium. Therefore, it is necessary to adjust the conditions for the complexing treatment to such an extent that the pulverization and complexing proceed sufficiently and the production of the silicon carbide does not occur.

Herein, the complexing treatment, in which the carbonaceous material is complexed with the composite obtained by containing or holding the fine crystal Si in the silicon oxide phase containing SiO₂ that is strongly bonded to Si through the mixing and stirring in a liquid phase, is described.

The mixing and stirring of the materials is carried out by using various types of stirring device, a ball mill, a bead mill and the combinations thereof.

The complexing of the silicon monoxide of the silicon-based particle with the carbon material or the carbon material precursor is preferably carried out by mixing those in a liquid obtained by using a dispersion medium because it is difficult to uniformly disperse the silicon monoxide of the silicon-based particle and the carbon material or the carbon material precursor without aggregating those by using a dry-type mixing device.

As the dispersion medium, an organic solvent or water, etc. can be used, and of these, it is preferable to use a liquid having a good affinity for the silicon monoxide, the carbon material and the carbon material precursor. Examples of the dispersion medium include ethanol, acetone, isopropyl alcohol, methyl ethyl ketone and ethyl acetate.

Also, in order to be uniformly mixed with the silicon monoxide of the silicon-based particle, the carbon material precursor is preferably soluble in the dispersion medium in the mixing stage, and more preferably a liquid and a readily polymerizable monomer or oligomer. Examples of the carbon material precursor include the organic materials which forms a furan resin, a xylene resin, a ketone resin, an amino resin, a melamine resin, a urea resin, an aniline resin, a urethane resin, a polyimide resin, a polyester resin, an epoxy resin and a phenolic resin.

The materials mixed in a liquid phase form the Si/SiOx-organic material composite through the solidification step or drying step.

The carbonizing and burning of the Si/SiOx-organic material composite is carried out under an inert atmosphere such as argon.

The temperature of the carbonizing and burning treatment is preferably 800° C. or higher and 1,400° C. or lower and more preferably 900° C. or higher and 1,100° C. or lower. Also, the carbonizing and burning time is preferably within a range of about 1 hour to 12 hours.

Also, examples of the method of coating the composite, which is obtained by containing or holding the fine crystal Si in the silicon oxide phase containing SiO₂ that is strongly bonded to Si, with the carbonaceous material include the coating method using a CVD method. In this coating method, a gaseous carbon source is flowed on the sample (composite), which has been heated at 800° C. or higher and 1000° C. or lower, using an inert gas as a carrier gas.

As the carbon source, benzene, toluene and styrene, etc. can be used. Also, because the sample is heated at 800° C. or higher and 1000° C. or lower when the sample is coated with the carbonaceous material by a CVD method, the carbonizing and burning can be carried out at the same time as the coating with the carbonaceous material.

Also, when the sample is coated with the carbonaceous material by a CVD method, the lithium compound and the SiO₂ source can be simultaneously added in the carbon source.

The product obtained by the carbonizing and burning is pulverized by using various mills, a milling apparatus or a grinder, etc. so as to adjust the particle size and the specific surface area. After the adjustment, the product was subjected to the classification using a sieve, to thereby obtain the negative electrode material having a suitable particle size.

Herein, the part, at which the silicon oxide phase is exposed, appears on the surface of the negative electrode material in this pulverizing step, and therefore, by subjecting the part to the coupling reaction using the isocyanate compound in the aforementioned manner, it is possible to obtain the effect of improving the initial charge and discharge efficiency as described above.

Also, it is preferable to use the particles of silicon itself in addition to the particles mainly composed of fine silicon monoxide as the silicon-based particles used in the present embodiment in terms of charge and discharge capacity. In this case, the silicon oxide phase is formed partially on the surface of the silicon particle, and therefore, by coating the part with the carbonaceous material, it is possible to obtain the same effect.

According to the negative electrode material for a nonaqueous electrolyte secondary battery of the present embodiment, the organic molecule R is bonded through a urethane bond to at least one of the surface layer part of the silicon particle, the surface layer part of the silicon oxide composite particle, and the surface layer part of the lithium-containing silicon oxide composite particle, and therefore, when this negative electrode material is used for a negative electrode material for a nonaqueous electrolyte secondary battery, it is possible to improve the charge and discharge capacity and the initial efficiency of the negative electrode.

### Second Embodiment

The second embodiment provides the negative electrode including a current collector; and the negative electrode mixture layer that is formed on the current collector and contains the aforementioned negative electrode material for a nonaqueous electrolyte secondary battery according to the first embodiment, a carbonaceous material and a binder.

In other words, the negative electrode according to the present embodiment includes the current collector; and the electrode mixture layer that is formed on the current collector and contains the aforementioned negative electrode material for a nonaqueous electrolyte secondary battery according to the first embodiment, the carbonaceous material and the binder.

The negative electrode according to the present embodiment is described as an electrode used for a nonaqueous electrolyte secondary battery, but the negative electrode according to the present embodiment can be used for various batteries.

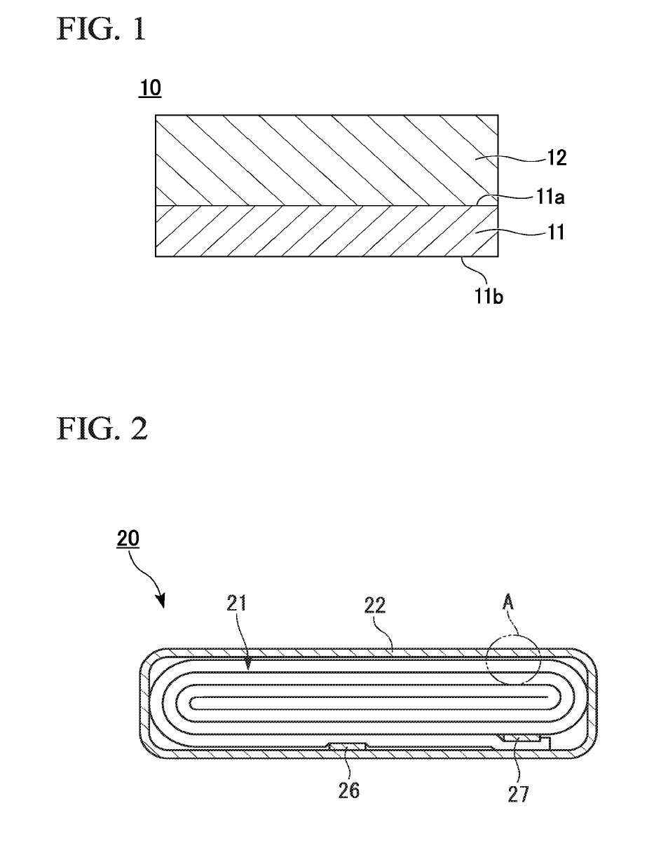

Hereinafter, the negative electrode according to the present embodiment is described in detail with reference to FIG. 1.

FIG. 1 is a schematic view illustrating the negative electrode according to the present embodiment.

The negative electrode 10 according to the present embodiment includes the negative electrode current collector 11; and the negative electrode mixture layer 12 as shown in FIG. 1.

The negative electrode mixture layer 12 is the layer which is provided on the one surface 11a of the negative electrode current collector 11 and is formed of the mixture containing the aforementioned negative electrode material for a nonaqueous electrolyte secondary battery according to the first embodiment. The negative electrode mixture layer 12 contains the binder and the aforementioned negative electrode material for a nonaqueous electrolyte secondary battery according to the first embodiment. The binder binds the negative electrode current collector 11 and the negative electrode mixture layer 12. Also, the negative electrode mixture layer 12 can contain an additive such as an electroconductive agent.

The thickness of the negative electrode mixture layer 12 is preferably within a range of 1.0 μm or more and 150 μm or less, and more preferably within a range of 10 μm or more and 100 μm or less. Therefore, when the negative electrode mixture layers 12 are provided on the both surfaces (the one surface 11a and the other surface 11b) of the negative electrode current collector 11, the total thickness of the negative electrode mixture layers 12 is within a range of 2.0 μm or more and 300 μm or less.

When the thickness of the negative electrode mixture layer 12 is within the aforementioned range, the large current discharge characteristics and cycle characteristics of the nonaqueous electrolyte secondary battery including the negative electrode 10 are improved significantly.

Regarding the blending ratio of the negative electrode material, the electroconductive agent and the binder in the negative electrode mixture layer 12, the negative electrode material is preferably blended within a range of 40 mass % or more and 95 mass % or less, the electroconductive agent is preferably blended within a range of 3 mass % or more and 58 mass % or less, and the binder is preferably blended within a range of 2 mass % or more and 20 mass % or less. When the blending ratio of the negative electrode material, the electroconductive agent and the binder is within the aforementioned range, it is possible to obtain the good large current discharge characteristics and cycle characteristics in the nonaqueous electrolyte secondary battery including the negative electrode 10.

The negative electrode current collector 11 is the electroconductive member to be bound with the negative electrode mixture layer 12. As the negative electrode current collector 11, it is possible to use an electroconductive substrate having a porous structure or a non-porous electroconductive substrate. These electroconductive substrates can be formed of an electroconductive material such as copper, nickel, alloys thereof or stainless steel. Of these electroconductive materials, copper and a copper alloy are the most preferable in terms of electroconductivity.

The thickness of the negative electrode current collector 11 is preferably within a range of 5 μm to 20 μm. When the thickness of the negative electrode current collector 11 is within the range, it is possible to achieve the balance between electrode strength and reduction in weight.

The electroconductive agent improves the current collection performance of the negative electrode material and suppresses the contact resistance between the negative electrode material and the negative current collector 11.

Examples of the electroconductive agent 14 include acetylene black, carbon black, coke, a carbon fiber, graphite, a metal compound powder and a metal powder. More preferable examples of the electroconductive agent 14 include the coke in which thermal treatment temperature is within a range from 800° C. to 2,000° C. and the average particle size is 10 μm; graphite; and the metal powders of TiO, TiC, TiN, Al, Ni, Cu and Fe, etc.

The electroconductive agent can be used alone or in combination of two or more.

The binder fills the gaps among the dispersed negative electrode materials, binds the negative electrode material and the electroconductive agent, and binds the negative electrode material and the negative electrode current collector 11.

Examples of the binder include polytetrafluoroethylene (PTFE), polyvinylidene fluoride (PVdF), polyacrylic acid, polysaccharides such as alginic acid and cellulose and the derivatives thereof, an ethylene-propylene-diene copolymer (EPDM), styrene-butadiene rubber (SBR), polyimide, polyamide, and polyamide-imide. Of these, the polymers such as polyimides having an imide structure are more preferable because the binding force for the negative electrode current collector 11 is high and the binding force between the negative electrode materials is enhanced.

The binder can be used alone or in combination of two or more. When the binder is used in combination of two or more, the life property of the negative electrode 10 can be improved by employing the combination of the binder having excellent binding property for the negative electrode materials and the binder having excellent binding property for the negative electrode material and the negative electrode current collector 11, or the combination of the binder having high hardness and the binder having excellent flexibility.

Next, the production method of the negative electrode 10 is described.

Firstly, the negative electrode material, the electroconductive agent and the binder are suspended in a general solvent so as to prepare a slurry.

Subsequently, the slurry is applied onto the one surface 11a of the negative electrode current collector 11 followed by drying to form the negative electrode mixture layer 12. Then, the negative electrode mixture layer 12 is subjected to pressing, to thereby obtain the negative electrode 10.

The negative electrode for a nonaqueous electrolyte secondary battery according to the present embodiment is formed by using the negative electrode material for a nonaqueous electrolyte secondary battery according to the first embodiment, and therefore, the charge and discharge cycle of the nonaqueous electrolyte secondary battery having the negative electrode is improved.

### Third Embodiment

The third embodiment provides the nonaqueous electrolyte secondary battery comprising the negative electrode containing the negative electrode material for a nonaqueous electrolyte secondary battery according to the aforementioned first embodiment, a positive electrode, a nonaqueous electrolyte, a separator and an exterior material.

More specifically, the nonaqueous electrolyte secondary battery according to the present embodiment includes an exterior material, a positive electrode that is housed in the external material, the negative electrode that is spatially separated from the positive electrode and is housed in the external material with a separator interposed therebetween, and a nonaqueous electrolyte charged in the external material.

Hereinafter, the negative electrode, the positive electrode, the nonaqueous electrolyte, the separator and the exterior material, which are constituent members of the nonaqueous electrolyte secondary battery according to the present embodiment, are described in detail.

### (1) Negative Electrode

As the negative electrode, the aforementioned negative electrode according to the second embodiment is used.

### (2) Positive Electrode

The positive electrode includes the positive electrode current collector and the positive electrode mixture layer that is formed on one surface or both surfaces of the positive electrode current collector and contains a positive electrode active material, an electroconductive agent and a binder. An electroconductive agent and a binder are optional components.

The thickness of the positive electrode mixture layer on one surface is preferably within a range of 1.0 μm or more and 150 μm or less, and more preferably within a range of 20 μm or more and 120 μm or less. Therefore, when the positive electrode mixture layers are provided on the both surfaces of the positive electrode current collector, the total thickness of the positive electrode mixture layers is within a range of 2.0 μm or more and 300 μm or less.

When the thickness of the positive electrode mixture layer is within the aforementioned range, the large current discharge characteristics and cycle characteristics of the nonaqueous electrolyte secondary battery including a positive electrode are improved significantly.

As the positive electrode active material, an oxide or a sulfide can be used. Examples of an oxide and a sulfide include manganese dioxide (MnO₂) which absorbs lithium, an iron oxide, a copper oxide, a nickel oxide, a lithium-manganese composite oxide (such as LiₓMn₂O₄ or LiₓMnO₂), a lithium-nickel composite oxide (such as LiₓNiO₂), a lithium-cobalt composite oxide (such as Li—CoO₂), a lithium-nickel-cobalt composite oxide (such as LiNi_{1-y}Co_{y}O₂), a lithium-manganese-cobalt composite oxide (such as LiₓMn_{y}Co₁₋₇O₂), a lithium-manganese-nickel composite oxide (such as LiₓMn_{2-y}Ni_{y}O₄) having a spinel structure, a lithium-phosphorus oxide (such as LiₓFePO₄, LiₓFe₁₋₇Mn_{y}PO₄, or LiₓCoPO₄) having an olivine structure, iron sulfate (Fe₂(SO₄)₃), a vanadium oxide (such as V₂O₅), and a lithium-nickel-cobalt-manganese composite oxide. In the aforementioned chemical formulae, x and y satisfy the relational expressions of “0≦x≦1” and “0≦y≦1”, respectively. As the positive electrode active material, these compounds can be used alone or in combination of two or more.

The positive electrode active material is preferably a compound having a high positive electrode voltage, and more preferable examples of the positive electrode active material include a lithium-manganese composite oxide (such as LiₓMn₂O₄), a lithium-nickel composite oxide (LiₓNiO₂), a lithium-cobalt composite oxide (LiₓCoO₂), a lithium-nickel-cobalt composite oxide (LiNi_{1-y}Co_{y}O₂), a lithium-manganese-nickel composite oxide (LiₓMn_{2-y}Ni_{y}O₄) having a spinel structure, a lithium-manganese-cobalt composite oxide (LiₓMn_{y}Co_{1-y}O₂), a lithium iron phosphate (LiₓFePO₄), and a lithium-nickel-cobalt-manganese composite oxide. In the aforementioned chemical formulae, x and y satisfy the relational expressions of “0<x≦1” and “0≦y≦1”, respectively.

In the case where an ambient temperature molten salt is used as the nonaqueous electrolyte of the nonaqueous electrolyte secondary battery, preferable examples of the positive electrode active material include a lithium iron phosphate, LiₓVPO₄F (0≦x≦1), a lithium-manganese composite oxide, a lithium-nickel composite oxide, or a lithium-nickel-cobalt composite oxide. Because these compounds have less reactivity with an ambient temperature molten salt, it is possible to improve the cycle life of the nonaqueous electrolyte secondary battery.

The average primary particle size of the positive electrode active material is preferably within a range of 100 nm to 1 μm. When the average primary particle size of the positive electrode active material is 100 nm or more, it is easy to handle in industrial manufacturing. Also, when the average primary particle size of the positive electrode active material is 1 μm or less, it is possible to make the lithium ion diffusion in solid proceed smoothly.

The electroconductive agent improves the current collection performance of the positive electrode active material and suppresses contact resistance between the positive electrode active material and the positive current collector. Examples of the electroconductive agent include agents containing acetylene black, carbon black, artificial graphite, natural graphite, a carbon fiber, and an electroconductive polymer.

The type of the electroconductive agent can be one, or two or more.

The binder fills the gap between the dispersed positive electrode active materials so as to bind the positive electrode active material and the electroconductive agent and to bind the positive electrode active material and the positive electrode current collector.

Examples of the binder include the organic materials such as polytetrafluoroethylene (PTFE), polyvinylidene fluoride (PVdF), and fluorine-based rubber and polyacrylic acid.

The type of the binder can be one, or two or more.

Also, examples of an organic solvent for dispersing the binder include N-methyl-2-pyrrolidone (NMP) and dimethylformamide (DMF).

Regarding the blending ratio of the positive electrode active material, the electroconductive agent and the hinder in the positive electrode mixture layer, the positive electrode active material is preferably blended within a range of 80 mass % or more and 95 mass % or less, the electroconductive agent is preferably blended within a range of 3 mass % or more and 20 mass % or less, and the binder is preferably blended within a range of 2 mass % or more and 7 mass % or less. When the blending ratio is within the aforementioned range, it is possible to obtain the good large current discharge characteristics and cycle characteristics in the nonaqueous electrolyte secondary battery including the positive electrode.

The positive electrode current collector is the electroconductive member to be bound with the positive electrode mixture layer. As the positive electrode current collector, an electroconductive substrate having a porous structure or a non-porous electroconductive substrate can be used.

The thickness of the positive electrode current collector is preferably within a range of 5 μm to 20 μm. When the thickness of the positive electrode current collector is within the range, it is possible to achieve the balance between electrode strength and reduction in weight.

Next, the production method of the positive electrode is described.

Firstly, the positive electrode active material, the electroconductive agent and the binder are suspended in a general solvent so as to prepare slurry.

Subsequently, the slurry is applied on the positive electrode current collector followed by drying to form the positive electrode mixture layer. Then, the positive electrode mixture layer is subjected to pressing, to thereby obtain the positive electrode.

Also, the positive electrode can be produced by molding the positive electrode active material, the binder and the electroconductive agent to be blended according to need in a pellet shape to form the positive electrode mixture layer, and disposing this positive electrode mixture layer on the positive electrode current collector.

### (3) Nonaqueous Electrolyte

As the nonaqueous electrolyte, a nonaqueous electrolyte solution, an electrolyte-impregnated polymer electrolyte, a polymer electrolyte or an inorganic solid electrolyte are used.

A nonaqueous electrolyte solution is a liquid nonaqueous electrolyte prepared by dissolving an electrolyte in a nonaqueous solvent (an organic solvent), and is held in the gap in the electrode group.

As a nonaqueous solvent, it is preferable to use the solvent which mainly contains the mixed solvent of cyclic carbonates (hereinafter, referred to as the “first solvent”) such as ethylene carbonate (EC), propylene carbonate (PC) and vinylene carbonate, and nonaqueous solvents having lower viscosity than the cyclic carbonates (hereinafter, referred to as the “second solvent”).

Examples of the second solvent include chain carbonates such as dimethyl carbonate (DMC), diethyl carbonate (DEC) and methylethyl carbonate (MEC); ethyl propionate; methyl propionate; γ-butyrolactone (GBL); acetonitrile (AN); ethyl acetate (EA); toluene; xylene; and methyl acetate (MA). These second solvents can be used alone or in a mixed solvent form of two or more. In particular, it is more preferable that the second solvent have a donor number of 16.5 or less.

It is preferable that the viscosity of the second solvent be 2.8 cPs or less at 25° C. Herein, 1 cPs is converted into 1 mPa·s. The blending percentage of ethylene carbonate or propylene carbonate in the mixed solvent of the first solvent and the second solvent is preferably 1.0 vol % or more and 80 vol % or less, and more preferably 20 vol % or more and 75 vol % or less.

Examples of an electrolyte contained in a nonaqueous electrolyte include lithium salts such as lithium perchlorate (LiClO₄), lithium hexafluorophosphate (LiPF₆), lithium tetrafluoroborate (LiBF₄), lithium hexafluoroarsenate (LiAsF₆), lithium trifluoromethanesulfonate (LiCF₃SO₃) and lithium bistrifluoromethylsulfonimide [LiN(CF₃SO₂)₂]. Among these, it is preferable to use lithium hexafluorophosphate or lithium tetrafluoroborate.

It is preferable that the dissolving amount of the electrolyte relative to the nonaqueous solvent contained in nonaqueous electrolyte be 0.5 mol/L or more and 2.0 mol/L or less.

### (4) Separator

The separator is placed between the positive electrode and the negative electrode.

The separator is formed of a porous film such as polyethylene (PE), polypropylene (PP), cellulose or polyvinylidene fluoride (PVdF), or a nonwoven fabric made of a synthetic resin, for example. Among these, a porous film formed of polyethylene or polypropylene is preferable because this kind of film can be melt at a certain temperature so as to block a current, which can improve safety.

The thickness of the separator is preferably 5 μm or more and 30 μm or less, and more preferably 10 μm or more and 25 μm or less. When the thickness of the separator is less than 5 μm, the strength of the separator is significantly deteriorated, and there is the possibility that the internal short circuit is likely to occur. Meanwhile, when the thickness of the separator is more than 30 μm, the distance between the positive electrode and the negative electrode is increased, and there is the possibility that the internal resistance is increased.

When the separator is allowed to stand for 1 hour at 120° C., the thermal shrinkage percentage is preferably 20% or less and more preferably 15% or less. When the thermal shrinkage percentage of the separator is more than 20%, there is the increased possibility that heating causes the short circuit between the positive electrode and the negative electrode.

The porosity of the separator is preferably 30% or more and 70% or less and more preferably 35% or more and 70% or less.

The reason why the porosity of the separator is preferably within the aforementioned range is as follows. When the porosity is less than 30%, there is the possibility that the high electrolyte-holding property cannot be obtained in the separator. Meanwhile, when the porosity is higher than 70%, there is the possibility that the sufficient strength cannot be obtained in the separator.

The air permeability of the separator is preferably 30 seconds/100 cm³ or more and 500 seconds/100 cm³ or less and more preferably 50 seconds/100 cm³ or more and 300 seconds/100 cm³ or less.

When the air permeability is less than 30 seconds/100 cm³, there is the possibility that the sufficient strength cannot be obtained in the separator. Meanwhile when the air permeability is higher than 500 seconds/100 cm³, there is the possibility that the high lithium ion mobility cannot be obtained in the separator.

### (5) Exterior Material

As the exterior material which houses the positive electrode, the negative electrode and the nonaqueous electrolyte, a metal container or an exterior container made of a laminated film.

As a metal container, the metal can formed of aluminum, an aluminum alloy, iron or stainless steel in a rectangular or cylindrical shape is used. Also, the thickness of the metal container is preferably 1 mm or less, more preferably 0.5 mm or less and much more preferably 0.2 mm or less.

As an aluminum alloy, an alloy containing an element such as magnesium, zinc or silicon is preferred. When a transition metal such as iron, copper, nickel or chromium is contained in the aluminum alloy, the content of the transition metal is preferably 100 ppm or less. Because the metal container made of the aluminum alloy has the much greater strength than the metal container made of aluminum, the thickness of the metal container can be reduced. As a result, it is possible to realize the thin and lightweight nonaqueous electrolyte secondary battery which has high power and excellent heat radiation property.

Examples of a laminated film include a multi-layer film in which an aluminum foil is coated with a resin film. Usable examples of a resin constituting a resin film include a polymer material such as polypropylene (PP), polyethylene (PE), nylon or polyethylene terephthalate (PET). Also, the thickness of the laminated film is preferably 0.5 mm or less and more preferably 0.2 mm or less. The purity of an aluminum foil is preferably 99.5% or more.

Herein, the present embodiment can be applied to the nonaqueous electrolyte battery having various shapes such as a flat type (thin type), a square type, a cylindrical type, a coin type and a button type.

Also, the nonaqueous electrolyte secondary battery according to the present embodiment can further include a lead which is electrically connected to the electrode group containing the positive electrode and the negative electrode. For example, the nonaqueous electrolyte secondary battery according to the present embodiment can include two leads. In this case, one of the leads is electrically connected to the positive electrode current collector tab and the other lead is electrically connected to the negative electrode current collector tab.

The material of the lead is not particularly limited, but for example, the same material for the positive electrode current collector and the negative electrode current collector is used.

The nonaqueous electrolyte secondary battery according to the present embodiment can further include a terminal which is electrically connected to the aforementioned lead and is drawn from the aforementioned exterior material. For example, the nonaqueous electrolyte secondary battery according to the present embodiment can include two terminals. In this case, one of the terminals is connected to the lead which is electrically connected to the positive electrode current collector tab and the other terminal is connected to the lead which is electrically connected to the negative electrode current collector tab.

The material of the terminal is not particularly limited, but for example, the same material for the positive electrode current collector and the negative electrode current collector is used.

### (6) Nonaqucous Electrolyte Secondary Battery

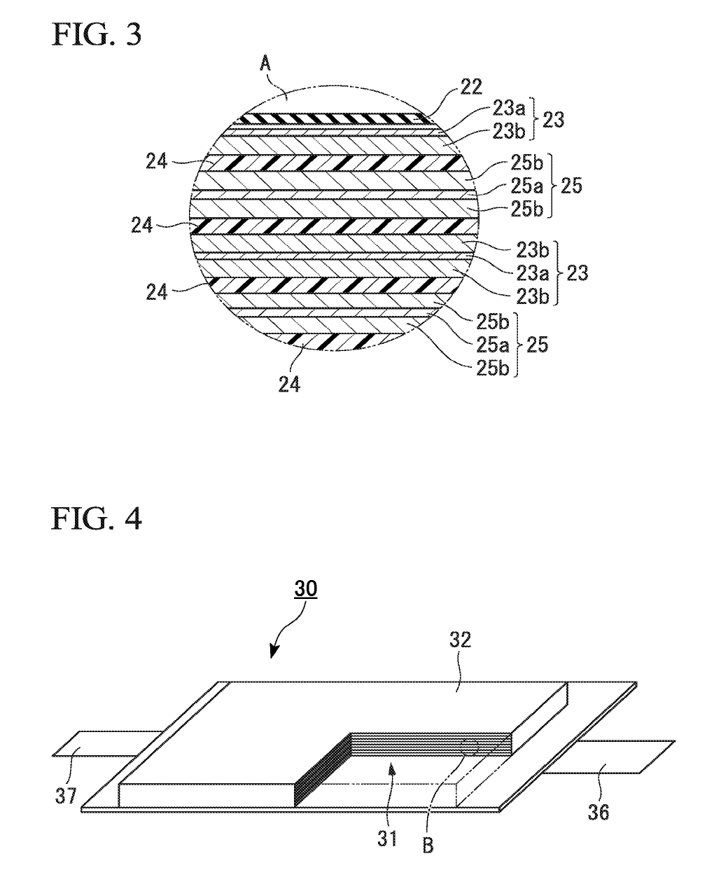

Next, the flat type nonaqueous electrolyte secondary battery (nonaqueous electrolyte secondary battery) 20 illustrated in FIG. 2 and FIG. 3 is described as an example of the nonaqueous electrolyte secondary battery according to the present embodiment. FIG. 2 is a schematic sectional view illustrating the cross-section of the flat type nonaqueous electrolyte secondary battery 20. FIG. 3 is an enlarged sectional view illustrating the part A illustrated in FIG. 2. These drawings are schematic diagrams for describing the nonaqueous electrolyte secondary battery according to the embodiment. The shapes, dimensions, ratios, and the like are different from those of actual device at some parts, but design of the shape, dimensions, ratios, and the like can be appropriately modified in consideration of the following description and known technologies.

The flat type nonaqueous electrolyte secondary battery 20 illustrated in FIG. 2 is configured such that the winding electrode group 21 with a flat shape is housed in the exterior material 22. The exterior material 22 may be a container obtained by forming a laminated film in a bag-like shape or may be a metal container. Also, the winding electrode group 21 with the flat shape is formed by spirally winding the laminated product obtained by laminating the negative electrode 23, the separator 24, the positive electrode 25 and the separator 24 from the outside, i.e. the side of the exterior material 22, in this order, followed by performing press-molding. As illustrated in FIG. 3, the negative electrode 23 located at the outermost periphery has the configuration in which the negative electrode layer 23b is formed on one surface of the negative electrode current collector 23a on the inner surface side. The negative electrodes 23 at the parts other than the outermost periphery have the configuration in which the negative electrode layers 23b are formed on both surfaces of the negative current collector 23a. Also, the positive electrode 25 has the configuration in which the positive electrode layers 25b arc formed on both surfaces of the positive current collector 25a. Herein, a gel-like nonaqueous electrolyte can be used instead of the separator 24.

In the vicinity of the outer peripheral end of the winding electrode group 21 illustrated in FIG. 2, the negative electrode terminal 26 is electrically connected to the negative current collector 23a of the negative electrode 23 of the outermost periphery. The positive electrode terminal 27 is electrically connected to the positive current collector 25a of the inner positive electrode 25. The negative electrode terminal 26 and the positive electrode terminal 27 extend toward the outer portion of the exterior material 22, and are connected to the extraction electrodes included in the exterior material 22.

When manufacturing the nonaqueous electrolyte secondary battery 20 including the exterior material formed of the laminated film, the winding electrode group 21 to which the negative electrode terminal 26 and the positive electrode terminal 27 are connected is charged in the exterior material 22 having the bag-like shape with an opening, the liquid nonaqueous electrolyte is injected from the opening of the exterior material 22, and the opening of the exterior material 22 with the bag-like shape is subjected to heat-sealing in the state of sandwiching the negative electrode terminal 26 and the positive electrode terminal 27 therebetween. Through this process, the winding electrode group 21 and the liquid nonaqueous electrolyte are completely sealed.

Also, when manufacturing the nonaqueous electrolyte battery 20 having the exterior material formed of the metal container, the winding electrode group 21 to which the negative electrode terminal 26 and the positive electrode terminal 27 are connected is charged in the metal container having an opening, the liquid nonaqueous electrolyte is injected from the opening of the exterior material 22, and the opening is sealed by mounting a cover member on the metal container.

For the negative electrode terminal 26, it is possible to use the material having electric stability and electroconductivity within a range of a potential equal to or nobler than 0 V and equal to or lower than 3 V with respect to lithium, for example. Specific examples of this material include aluminum and an aluminum alloy containing an element such as Mg, Ti, Zn, Mn, Fe, Cu or Si. Also, it is more preferable that the negative electrode terminal 26 be formed of the same material as the negative current collector 23a in order to reduce the contact resistance with the negative current collector 23a.

For the positive electrode terminal 27, it is possible to use the material having electric stability and electroconductivity within a range of a potential equal to or higher than 3 V and equal to or lower than 4.25 V with respect to lithium. Specific examples of this material include aluminum and an aluminum alloy containing an element such as Mg, Ti, Zn, Mn, Fe, Cu or Si. It is more preferable that the positive electrode terminal 27 be formed of the same material as the positive current collector 25a in order to reduce the contact resistance with the positive current collector 25a.

Hereinafter, the exterior material 22, the negative electrode 23, the positive electrode 25, the separator 24, and the nonaqueous electrolyte which are constituent members of the nonaqueous electrolyte battery 20 is described in detail.

### (1) Exterior Material

As the exterior material 22, the aforementioned exterior material is used.

### (2) Negative Electrode

As the negative electrode 23, the aforementioned negative electrode is used.

### (3) Positive Electrode

As the positive electrode 25, the aforementioned positive electrode is used.

### (4) Separator

As the separator 24, the aforementioned separator is used.

### (5) Nonaqueous Electrolyte

As the nonaqueous electrolyte, the aforementioned nonaqueous electrolyte is used.

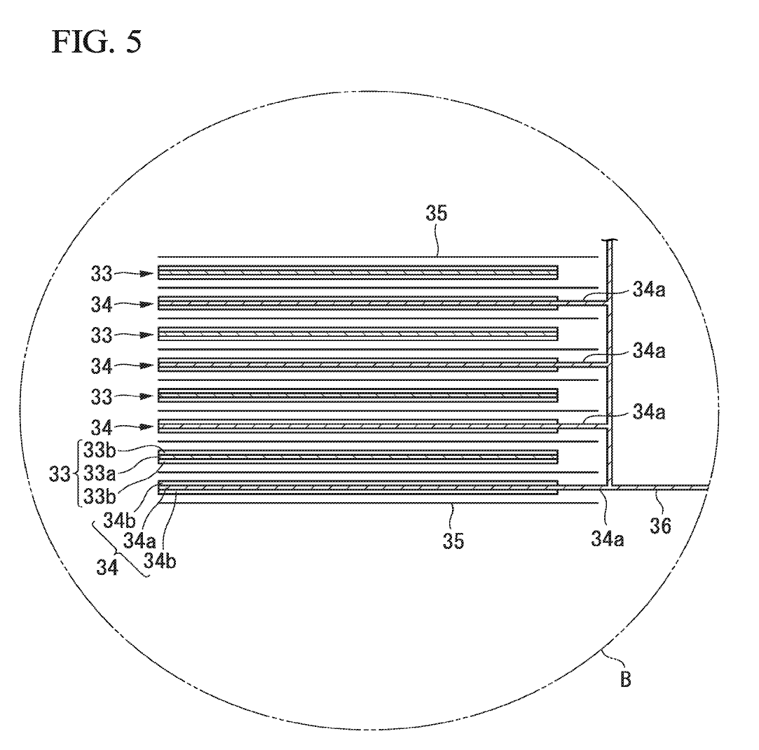

The configuration of the nonaqueous electrolyte secondary battery according to the third embodiment is not limited to the aforementioned configuration illustrated in FIG. 2 and FIG. 3. For example, the batteries having the configurations illustrated in FIG. 4 and FIG. 5 can be used. FIG. 4 is a partial cutout perspective view schematically illustrating another flat type nonaqueous electrolyte secondary battery according to the third embodiment. FIG. 5 is an enlarged schematic sectional view illustrating the part B of FIG. 4.

The nonaqueous electrolyte secondary battery 30 illustrated in FIG. 4 and FIG. 5 is configured such that the lamination type electrode group 31 is housed in the exterior member 32. As illustrated in FIG. 5, the lamination type electrode group 31 has the structure in which the positive electrodes 33 and negative electrodes 34 are alternately laminated while interposing separators 35 therebetween.

The plurality of positive electrodes 33 are present and each includes the positive electrode current collector 33a and the positive electrode layers 33b supported on both surfaces of the positive electrode current collector 33a. The positive electrode layer 33b contains the positive electrode active material.

The plurality of negative electrodes 34 are present and each includes the negative electrode current collector 34a and the negative electrode layers 34b supported on both surfaces of the negative electrode current collector 34a. The negative electrode layer 34b contains the negative electrode active material. One side of the negative electrode current collector 34a of each negative electrode 34 protrudes from the negative electrode 34. The protruding negative electrode current collector 34a is electrically connected to a strip-shaped negative electrode terminal 36. The front end of the strip-shaped negative electrode terminal 36 is drawn from the exterior member 32 to the outside. Although not illustrated, in the positive electrode current collector 33a of the positive electrode 33, the side located opposite to the protruding side of the negative electrode current collector 34a protrudes from the positive electrode 33. The positive electrode current collector 33a protruding from the positive electrode 33 is electrically connected to the strip-shaped positive electrode terminal 37. The front end of the strip-shaped positive electrode terminal 37 is located on an opposite side to the negative electrode terminal 36, and is drawn from the side of the exterior member 32 to the outside.

The material, a mixture ratio, dimensions, and the like of each member included in the nonaqueous electrolyte secondary battery 30 illustrated in FIG. 4 and FIG. 5 are configured to be the same as those of each constituent member of the nonaqueous electrolyte secondary battery 20 described in FIG. 2 and FIG. 3.

According to the present embodiment described above, it is possible to provide the nonaqueous electrolyte secondary battery.

The nonaqueous electrolyte secondary battery according to the present embodiment includes the negative electrode, the positive electrode, the nonaqueous electrolyte, the separator and the exterior material. The negative electrode is formed by using the aforementioned negative electrode material for a nonaqueous electrolyte secondary battery according to the first embodiment.

This kind of the nonaqueous electrolyte secondary battery is excellent in the charge and discharge capacity and the initial efficiency, and thus, the charge and discharge cycle is improved.

### Fourth Embodiment

Next, the nonaqueous electrolyte secondary battery pack according to the fourth embodiment is described in detail.

The nonaqueous electrolyte secondary battery pack according to the present embodiment includes at least one nonaqueous electrolyte secondary battery according to the aforementioned third embodiment (i.e. a single battery). When the plurality of single batteries are included in the nonaqueous electrolyte secondary battery pack, the respective single batteries are disposed so as to be electrically connected in series, in parallel, or in series and parallel.

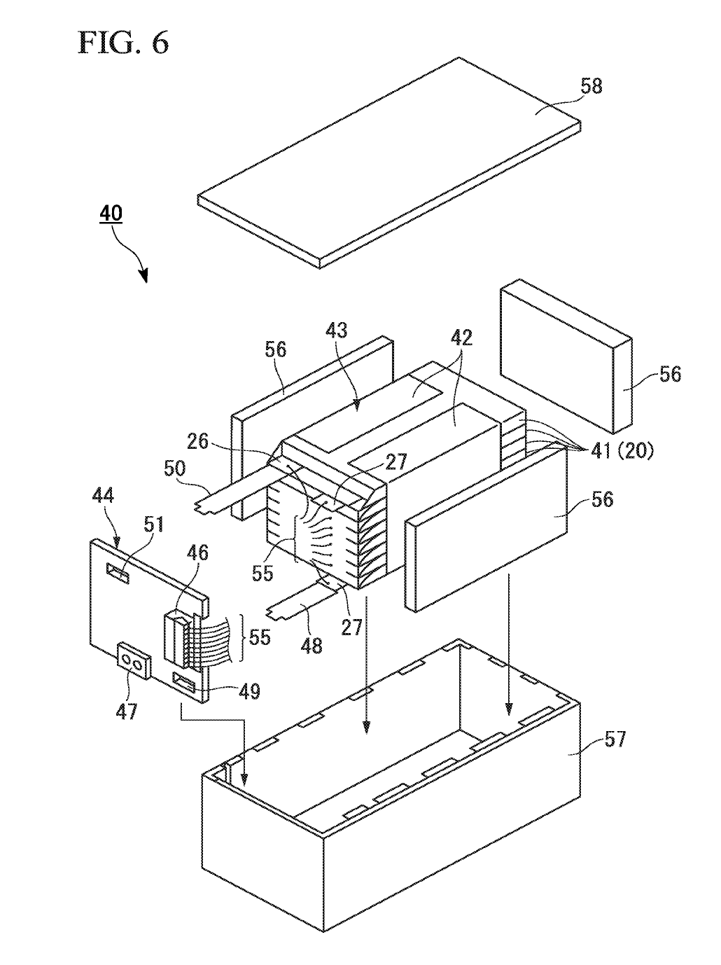

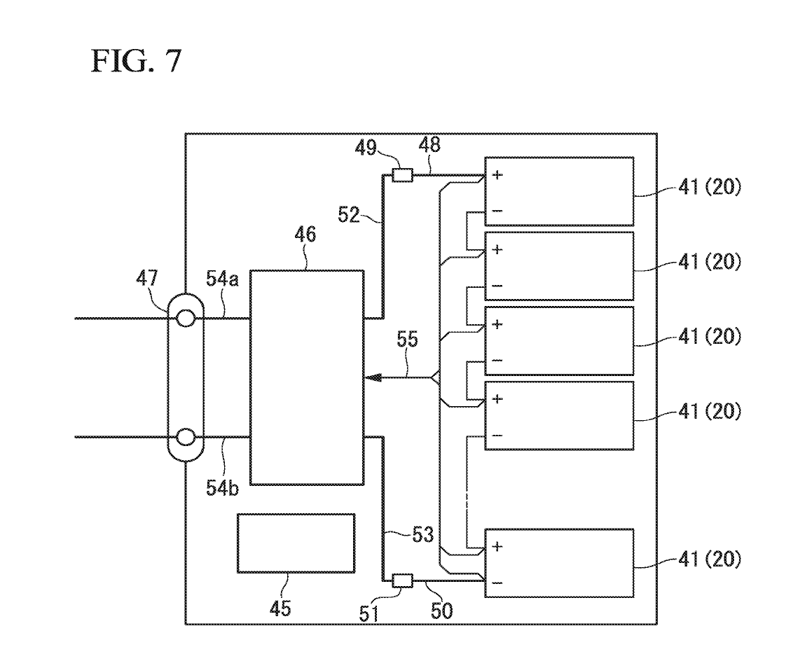

Referring to FIG. 6 and FIG. 7, the nonaqueous electrolyte secondary battery pack 40 according to the present embodiment is described in detail. In the battery pack 40 illustrated in FIG. 6, the flat type nonaqueous electrolyte battery 20 illustrated in FIG. 2 is used as the single battery 41.

The plurality of single batteries 41 are laminated so that the negative electrode terminals 26 and the positive electrode terminals 27 extending to the outside are arranged in the same direction, and thus the assembled batteries 43 are configured by fastening with the adhesive tape 42. These single batteries 41 are connected mutually and electrically in series, as illustrated in FIG. 6 and FIG. 7.

The printed wiring board 44 is disposed to face the side surfaces of the single batteries 41 in which the negative electrode terminals 26 and the positive electrode terminals 27 extend. As illustrated in FIG. 6, the thermistor 45 (see FIG. 7), the protective circuit 46 and the electrifying terminal 47 to an external device are mounted on the printed wiring board 44. Herein, an insulation plate (not illustrated) is mounted on the surface of the printed wiring board 44 facing the assembled batteries 43 in order to avoid unnecessary connection with wirings of the assembled batteries 43.

The positive electrode-side lead 48 is connected to the positive electrode terminal 27 located in the lowermost layer of the assembled batteries 43, and the front end of the positive electrode-side lead 48 is inserted into the positive electrode-side connector 49 of the printed wiring board 44 to be electrically connected. The negative electrode-side lead 50 is connected to the negative electrode terminal 26 located in the uppermost layer of the assembled batteries 43, and the front end of the negative electrode-side lead 50 is inserted into the negative electrode-side connector 51 of the printed wiring board 44 to be electrically connected. These positive electrode-side connector 49 and negative electrode-side connector 51 are connected to the protective circuit 46 via wirings 52 and 53 (see FIG. 7) formed in the printed wiring board 44.

The thermistor 45 is used to detect a temperature of the single battery 41. Although not illustrated in FIG. 6, the thermistor 45 is installed near the single batteries 41, and a detection signal is transmitted to the protective circuit 46. The protective circuit 46 can block the plus-side wiring 54a and the minus-side wiring 54b between the protective circuit 46 and the electrifying terminal 47 for an external device under a predetermined condition. Here, for example, the predetermined condition means that the detection temperature of the thermistor 45 becomes equal to or greater than a predetermined temperature. In addition, the predetermined condition also means that an overcharge, overdischarge, overcurrent, or the like of the single battery 41 be detected. The detection of the overcharge or the like is performed for the respective single batteries 41 or all of the single batteries 41. Herein, when the overcharge or the like is detected in the respective single batteries 41, a battery voltage may be detected, or a positive electrode potential or a negative electrode potential may be detected. In the latter case, a lithium electrode used as a reference electrode is inserted into the respective single batteries 41. In the case of FIG. 6 and FIG. 7, wirings 55 for voltage detection are connected to the respective single batteries 41 and detection signals are transmitted to the protective circuit 46 via the wirings 55.

As illustrated in FIG. 6, the protective sheets 56 formed of rubber or resin are disposed on three side surfaces of the assembled batteries 43 excluding the side surface from which the positive electrode terminals 27 and the negative electrode terminals 26 protrude.

The assembled batteries 43 are stored together with the respective protective sheets 56 and the printed wiring board 44 in the storing container 57. That is, the protective sheets 56 are disposed on both of the inner surfaces of the storing container 57 in the longer side direction and the inner surface in the shorter side direction, and the printed wiring board 44 is disposed on the inner surface opposite to the protective sheet 56 in the shorter side direction. The assembled batteries 43 are located in a space surrounded by the protective sheets 56 and the printed wiring board 44. The cover 58 is mounted on the upper surface of the storing container 57.

When the assembled batteries 43 are fixed, a thermal shrinkage tape may be used instead of the adhesive tape 42. In this case, protective sheets are disposed on both side surfaces of the assembled batteries, the thermal shrinkage tape is circled, and then the thermal shrinkage tape is subjected to thermal shrinkage, so that the assembled batteries are fastened.

Here, in FIG. 6 and FIG. 7, the single batteries 41 connected in series are illustrated. However, to increase a battery capacity, the single batteries 41 may be connected in parallel or may be connected in a combination form of series connection and parallel connection. The assembled battery packs can also be connected in series or in parallel.

According to the aforementioned present embodiment, it is possible to provide the nonaqueous electrolyte secondary battery pack. The nonaqueous electrolyte secondary battery pack according to the present embodiment includes at least one of the aforementioned nonaqueous electrolyte secondary battery according to the third embodiment.

This kind of nonaqueous electrolyte secondary battery pack has the excellent charge and discharge cycle.

Herein, the form of the nonaqueous electrolyte secondary battery pack can be appropriately modified according to a use application. A use application of the nonaqueous electrolyte secondary battery pack according to the embodiment is preferably one which is required to show excellent cycle characteristics when a large current is extracted. Specifically, the battery pack can be used for power of digital cameras, a two-wheeled or four-wheeled hybrid electric vehicle, a two-wheeled or four-wheeled electric vehicle, an assist bicycle, and the like. In particular, the nonaqueous electrolyte secondary battery pack using the nonaqueous electrolyte secondary batteries with excellent high temperature characteristics is appropriately used for vehicles.

### EXAMPLES

Hereinafter, the aforementioned embodiments are described on the basis of the examples.

### Example 1

The silicon monoxide powder was pulverized for a predetermined time by the continuous bead mill apparatus using beads having the particle size of 0.5 μm and ethanol as a dispersion medium.

Subsequently, the silicon monoxide powder was pulverized for a predetermined time by the planetary ball mill using a ball having the particle size of 0.1 μm and ethanol as a dispersion medium, to thereby produce the silicon monoxide fine powder. The silicon monoxide powder obtained through the fine pulverization treatment was burned for 3 hours at 1,100° C. under an argon gas atmosphere, and then was cooled to room temperature, to thereby obtain the negative electrode active material.

Meanwhile, the 2 mass % ethyl acetate solution of 1,3-bis(isocyanatomethyl)benzene was prepared, and the aforementioned negative electrode active material was added into this solution. After the solution was stirred at room temperature for 1 hour, the filtration was carried out to thereby obtain the solid component.

Subsequently, the obtained solid component was washed with acetone several times, and then, was dried under vacuum at 50° C. In this manner, the surface of the silicon oxide phase in the negative electrode active material was subjected to the coupling treatment through a urethane bond, to thereby obtain the negative electrode material of Example 1.

The obtained negative electrode material was subjected to the analysis using Fourier Transform Infrared Spectroscopy (FT-IR), and the amide bond having the peak around 1510 cm⁻¹ and the carbonyl group derived from the urethane bond, which had the peak around 1700 cm⁻¹, were observed. Therefore, it was confirmed that m-xylylene was coupled with the silicon oxide phase in the negative electrode active material through the urethane bond.

The aforementioned negative electrode material 78 mass %, the graphite 15 mass % having the average primary particle size of 3 μm, and the polyimide 8 mass % were kneaded by using NMP as a dispersion medium, to thereby prepare the negative electrode slurry.

Subsequently, the negative electrode slurry was applied with an interval of 80 μm onto the copper foil having the thickness of 12 μm, dried for 2 hours at 100° C., and rolled at the pressure of 1.0 kN. Then, the rolled negative electrode was cut into a predetermined size, and was dried for 2 hours at 250° C. Then, the dried negative electrode was cut into a predetermined size, and was dried under vacuum for 12 hours at 100° C., to thereby obtain the test electrode.

### “Evaluation of Electrochemical Characteristics”

### (Production of Electrochemical Measuring Cell)

The electrochemical measuring cell was produced under an argon atmosphere by using the aforementioned test electrode, the metal lithium foil as the counter electrode and the reference electrode, and the nonaqueous electrolyte. The 1 M solution, which was produced by dissolving LiPF₆ in the mixed solvent of ethylene carbonate (EC) and diethyl carbonate (DEC) (the volume ratio of EC:DEC=1:2), was used as the nonaqueous electrolyte.

### (Electrochemical Measurement)

The charge and discharge test was carried out at room temperature by using the aforementioned electrochemical measuring cell.

Regarding the conditions for the charge and discharge test, the charge was carried out at the current density of 1 mA/cm² until the electrical potential difference between the reference electrode and the test electrode became 0.01 V, the constant voltage charge was carried out for 24 hours at 0.01 V, and then the discharge was carried out at the current density of 1 mA/cm² to reach 1.5 V. The charge capacity, the discharge capacity and the charge and discharge efficiency (the discharge capacity/the charge capacity) were measured by the charge and discharge test. The results are shown in Table 1.

### Example 2

The silicon monoxide fine powder before the coupling treatment in Example 1, the graphite powder having the average primary particle size of 3 μm, and the carbonaceous material were complexed by the method described below.

The silicon monoxide fine powder 2.8 g, the graphite powder 0.1 g and the carbon fiber 0.01 g having the average diameter of 180 nm were added in the mixed solvent of the resole resin 3.0 g and ethanol 5 g, and were kneaded by a kneader, to thereby prepare the slurry mixture.

This mixture was dried at 80° C. so as to evaporate ethanol. Then, the mixture was put into an oven and cured for 2 hours at 150° C., to thereby obtain the silicon/carbon composite.

The obtained silicon/carbon composite was burned under an argon gas atmosphere at 1,100° C. for 3 hours, and was cooled to room temperature. Then, the silicon/carbon composite was pulverized, and was sieved by using the sieve having the diameter of 20 μm, to thereby obtain the negative electrode material below the sieve.

This negative electrode material was analyzed by X-ray photoelectron spectroscopy (XPS), and then, it was found that the silicon oxide phase was exposed on 25% of the total surface area of the negative electrode material.

Meanwhile, the 2 mass % ethyl acetate solution of 1,3-bis(isocyanatomethyl)benzene was prepared, and the aforementioned negative electrode material was added in this solution. After the solution was stirred at room temperature for 1 hour, the filtration was carried out to thereby obtain the solid component.

Subsequently, the obtained solid component was washed with acetone several times, and then, was dried under vacuum at 50° C. In this manner, the surface of the silicon oxide phase in the negative electrode material was subjected to the coupling treatment through a urethane bond, to thereby obtain the negative electrode material of Example 2.

The obtained negative electrode material was subjected to the analysis using Fourier Transform Infrared Spectroscopy (FT-IR), and the amide bond having the peak around 1510 cm⁻¹ and the carbonyl group derived from the urethane bond, which had the peak around 1700 cm⁻¹, were observed. Therefore, it was confirmed that m-xylylene was coupled with the silicon oxide phase in the negative electrode material through the urethane bond.

The aforementioned negative electrode material 78 mass %, the graphite 15 mass % having the average primary particle size of 3 μm, and the polyimide 8 mass % were kneaded by using NMP as a dispersion medium, to thereby prepare the negative electrode slurry.

Subsequently, the negative electrode slurry was applied with an interval of 80 μm onto the copper foil having the thickness of 12 μm, dried for 2 hours at 100° C., and rolled at the pressure of 1.0 kN. Then, the rolled negative electrode was cut into a predetermined size, and was dried for 2 hours at 250° C. Then, the dried negative electrode was cut into a predetermined size, and was dried under vacuum for 12 hours at 100° C., to thereby obtain the test electrode.

The electrochemical measuring cell was produced by using the obtained test electrode in the same manner as Example 1.

The electrochemical measurement was carried out for the obtained electrochemical measuring cell in the same manner as Example 1. The results are shown in Table 1.

### Example 3

The negative electrode active material was subjected to the coupling treatment in the same manner as Example 1 except for using the silicon fine particle having the average primary particle size of about 80 nm as the negative electrode active material, to thereby obtain the negative electrode material of Example 3.

The obtained negative electrode material was subjected to the analysis using Fourier Transform Infrared Spectroscopy (FT-IR), and the amide bond having the peak around 1510 cm⁻¹ and the carbonyl group derived from the urethane bond, which had the peak around 1700 cm⁻¹, were observed. Therefore, it was confirmed that m-xylylene was coupled with the silicon oxide phase in the negative electrode material through the urethane bond.

The aforementioned negative electrode material 42 mass %, the graphite 50 mass % having the average primary particle size of 3 μm, and the polyimide 8 mass % were kneaded by using NMP as a dispersion medium, to thereby prepare the negative electrode slurry.

Subsequently, the negative electrode slurry was applied with an interval of 40 μm onto the copper foil having the thickness of 12 dried for 2 hours at 100° C., and rolled at the pressure of 1.0 kN. Then, the rolled negative electrode was cut into a predetermined size, and was dried under an argon gas atmosphere for 2 hours at 250° C. Then, the dried negative electrode was cut into a predetermined size, and was dried under vacuum for 12 hours at 100° C., to thereby obtain the test electrode.

The electrochemical measuring cell was produced by using the obtained test electrode in the same manner as Example 1.

The electrochemical measurement was carried out for the obtained electrochemical measuring cell in the same manner as Example 1. The results are shown in Table 1.

### Example 4

The negative electrode material before the coupling treatment was obtained in the same manner as Example 2 except for using the silicon fine particle having the average primary particle size of about 80 nm as the negative electrode active material.

This negative electrode material was analyzed by X-ray photoelectron spectroscopy (XPS), and then, it was found that the silicon oxide phase was exposed on 19% of the total surface area of the negative electrode material.

The obtained negative electrode material was subjected to the coupling treatment in the same manner as Example 2, to thereby obtain the negative electrode material of Example 4.

The obtained negative electrode material was subjected to the analysis using Fourier Transform Infrared Spectroscopy (FT-IR), and the amide bond having the peak around 1510 cm⁻¹ and the carbonyl group derived from the urethane bond, which had the peak around 1700 cm⁻¹, were observed. Therefore, it was confirmed that m-xylylene was coupled with the silicon oxide phase in the negative electrode material through the urethane bond.

The aforementioned negative electrode material 78 mass %, the graphite 15 mass % having the average primary particle size of 3 μm, and the polyimide 8 mass % were kneaded by using NMP as a dispersion medium, to thereby prepare the negative electrode slurry.

Subsequently, the negative electrode slurry was applied with an interval of 40 μm onto the copper foil having the thickness of 12 μm, dried for 2 hours at 100° C., and rolled at the pressure of 1.0 kN. Then, the rolled negative electrode was cut into a predetermined size, and was subjected to the thermal treatment for 2 hours at 250° C. Then, the dried negative electrode was cut into a predetermined size, and dried under vacuum for 12 hours at 100° C., to thereby obtain the test electrode.

The electrochemical measuring cell was produced by using the obtained test electrode in the same manner as Example 1.

The electrochemical measurement was carried out for the obtained electrochemical measuring cell in the same manner as Example 1. The results are shown in Table 1.

### Comparative Example 1

The test electrode was produced in the same manner as Example 1 except for using the silicon monoxide fine powder before the coupling treatment obtained in Example 1 as the negative electrode active material.

The electrochemical measuring cell was produced by using the obtained test electrode in the same manner as Example 1.

The electrochemical measurement was carried out for the obtained electrochemical measuring cell in the same manner as Example 1. The results are shown in Table 1.

### Comparative Example 2

The test electrode was produced in the same manner as Example 1 except for using the silicon/carbon composite before the coupling treatment obtained in Example 2 as the negative electrode material.

The electrochemical measuring cell was produced by using the obtained test electrode in the same manner as Example 1.

The electrochemical measurement was carried out for the obtained electrochemical measuring cell in the same manner as Example 1. The results are shown in Table 1.

### Comparative Example 3

The test electrode was produced in the same manner as Example 3 except for using the silicon fine particle having the average primary particle size of about 80 nm as the negative electrode active material.

The electrochemical measuring cell was produced by using the obtained test electrode in the same manner as Example 1.

The electrochemical measurement was carried out for the obtained electrochemical measuring cell in the same manner as Example 1. The results arc shown in Table 1.

### Comparative Example 4

The test electrode was produced in the same manner as Example 4 except for using the silicon/carbon composite before the coupling treatment obtained in Example 2 as the negative electrode material.

The electrochemical measuring cell was produced by using the obtained test electrode in the same manner as Example 1.

The electrochemical measurement was carried out for the obtained electrochemical measuring cell in the same manner as Example 1. The results are shown in Table 1.

TABLE 1

| | Charge | Discharge | Charge and |
|---|---|---|---|
| | Capacity | Capacity | Discharge |
| | [mAh/g] | [mAh/g] | Efficiency [%] |
| Example 1 | 2587 | 2095 | 81 |
| Example 2 | 1390 | 1154 | 83 |
| Example 3 | 2010 | 1908 | 95 |
| Example 4 | 2740 | 2514 | 92 |
| Comparative | 2600 | 1510 | 58 |
| Example 1 | | | |
| Comparative | 1405 | 905 | 64 |
| Example 2 | | | |
| Comparative | 1811 | 1347 | 74 |
| Example 3 | | | |
| Comparative | 2815 | 2321 | 82 |
| Example 4 | | | |

From the results of Table 1, it was found that the charge and discharge efficiencies of the test electrodes (negative electrodes) were high in Examples 1 to 4.

By contrast, in Comparative Examples 1 to 4, lithium was rapidly increased in the silicon oxide phase during the charge to thereby form the lithium silicate stable phase, and there was the irreversible capacity corresponding to the lithium silicate stable phase. For this reason, the charge and discharge efficiency of the test electrodes (negative electrodes) were low.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A negative electrode material for a nonaqueous electrolyte secondary battery comprising:
at least one selected from a silicon particle, a silicon oxide composite particle and a lithium-containing silicon oxide composite particle; and
an organic molecule R, wherein
the silicon oxide composite particle contains a silicon oxide phase formed of SiOₓ (1≦x≦2) and a silicon phase formed of Si which is contained or held in the silicon oxide phase,
the lithium-containing silicon oxide composite particle is the silicon oxide composite particle containing lithium,
the organic molecule R is bonded through a urethane bond to at least one of a surface layer part of the silicon particle and a surface layer part of the silicon oxide phase, and
the organic molecule R represents a chain hydrocarbon group having 1 to 20 carbon atoms, cyclic hydrocarbon group having 1 to 20 carbon atoms or an aromatic hydrocarbon group having 1 to 20 carbon atoms; or a chain hydrocarbon group having 1 to 20 carbon atoms, cyclic hydrocarbon group having 1 to 20 carbon atoms or an aromatic hydrocarbon group having 1 to 20 carbon atoms in which at least one of carbon and hydrogen atoms are substituted by at least one selected from the group consisting of a halogen atom, an oxygen atom, a sulfur atom, a nitrogen atom and a silicon atom.

2. The negative electrode material according to claim 1, wherein
the organic molecule R is bonded through the urethane bond to at least a part of the silicon oxide phase that is exposed on surfaces of the silicon particle, the silicon oxide composite particle and the lithium-containing silicon oxide composite particle, and
a part or all of the silicon particle, the silicon oxide composite particle and the lithium-containing silicon oxide composite particle are coated with the organic molecule R.

3. A negative electrode for a nonaqueous electrolyte secondary battery comprising the negative electrode material according to claim 1; a carbonaceous material; and a binder.

4. A nonaqueous electrolyte secondary battery comprising:
an exterior material;
a positive electrode that is housed in the external material,
a separator that is housed in the external material,
the negative electrode according to claim 3 which is spatially separated from the positive electrode in the external material and is housed through the separator; and
a nonaqueous electrolyte charged in the external material.

5. A battery pack comprising one or more of the nonaqueous electrolyte secondary battery according to claim 4.

6. A negative electrode for a nonaqueous electrolyte secondary battery comprising the negative electrode material according to claim 2; a carbonaceous material; and a binder.

7. A nonaqueous electrolyte secondary battery comprising:
an exterior material;
a positive electrode that is housed in the external material,
a separator that is housed in the external material,
the negative electrode according to claim 6 which is spatially separated from the positive electrode in the external material and is housed through the separator; and
a nonaqueous electrolyte charged in the external material.

8. A battery pack comprising one or more of the nonaqueous electrolyte secondary battery according to claim 7.
